(19) United States
(12) Patent Application Publication
(10) Pub. No.: US 2015/0055561 A1
(43) Pub. Date: Feb. 26, 2015

(54) METHOD AND APPARATUS FOR PROVIDING SERVICES ACROSS SERVICE DOMAINS

(71) Applicant: ALCATEL-LUCENT USA INC., Murray Hill, NJ (US)

(72) Inventors: Andre Beck, Batavia, IL (US); James R. Ensor, Red Bank, NJ (US); Markus A. Hofmann, Fair Haven, NJ (US)

(73) Assignee: ALCATEL-LUCENT USA INC., Murray Hill, NJ (US)

(21) Appl. No.: 14/533,633

(22) Filed: Nov. 5, 2014

Related U.S. Application Data
(63) Continuation of application No. 11/864,349, filed on Sep. 28, 2007.

(51) Int. Cl. H04M 7/12; H04W 8/04; H04L 29/06

(52) U.S. Cl. CPC H04M 7/128; H04L 65/40; H04W 8/04; H04L 65/1069
USPC 370/328; 370/352

(57) ABSTRACT

The present invention supports services that span multiple service domains. In one embodiment, the present invention provides service-level interaction between an enterprise network and a non-enterprise network (or networks), thereby enabling enterprise users at remote locations (i.e., at home, on vacation, or at other locations remote from the enterprise location) to use services typically only available to the enterprise users while at the enterprise location (e.g., while in the office). The present invention provides a calendar notification service, whereby a calendar notification originating in an enterprise network is provided to a remote enterprise user via a non-enterprise network. The present invention provides an enterprise dialing plan service, whereby a remote enterprise user may register a remote user device to be able to use an enterprise dialing plan. Once registered, the remote enterprise user may use the enterprise dialing plan from the remote user device to place calls to local enterprise users at local user devices connected to the enterprise network and, similarly, local enterprise users may use the enterprise dialing plan to place calls to the remote enterprise user at the remote user device.

### CROSS-REFERENCE TO RELATED APPLICATION

This application is a continuation of U.S. patent application Ser. No. 11/864,349, filed on Sep. 28, 2007, entitled “METHOD AND APPARATUS FOR PROVIDING SERVICES ACROSS SERVICE DOMAINS”, which is hereby incorporated herein by reference.

### FIELD OF THE INVENTION

The invention relates to the field of communication networks and, more specifically, to delivery of services over communication networks.

### BACKGROUND OF THE INVENTION

In general, most telephony services are implemented either within a first service domain or within a second service domain. For example, telephony services, such call forwarding, voicemail, and the like, are provided either by application servers within a carrier telephony network or by enterprise services systems within enterprise networks. In other words, there is currently a lack of services spanning service domains.

### SUMMARY OF THE INVENTION

Various deficiencies in the prior art are addressed through the invention of a method and apparatus for interaction between multiple service domains for delivering services available from one service domain to users using one or more other service domains. In one embodiment, the present invention enables service-level interaction between an enterprise network and a non-enterprise network (or networks), thereby enabling enterprise users at remote locations (i.e., at home, on vacation, or at other locations that are remote from the enterprise location) to use services typically only available to the enterprise users while at the enterprise location (e.g., while in the office).

In one embodiment, the present invention provides a notification service, whereby a notification that originates in an enterprise network is provided to a remote employee via at least one non-enterprise network. In one embodiment, a method for delivering a notification generated in an enterprise network to a user via a non-enterprise network includes receiving the notification at the non-enterprise network, identifying an intended recipient of the received notification, and, in response to a determination that a service of the non-enterprise network is active for the intended recipient, propagating the notification toward the intended recipient via the non-enterprise network.

In one embodiment, the present invention provides an enterprise dialing plan service, whereby a remote user may register a remote user device that is connected to a carrier network (i.e., one which is outside of the enterprise network) to be able to use an enterprise dialing plan. The enterprise dialing plan service enables the remote user (via the remote user device registered by the remote user) to use the enterprise dialing plan to place calls to local users at local user devices connected to the enterprise network. The enterprise dialing plan service may also enable local users (via local user devices connected to the enterprise network), to use the enterprise dialing plan to place calls to the remote user at the remote user device.

### BRIEF DESCRIPTION OF THE DRAWINGS

The teachings of the present invention can be readily understood by considering the following detailed description in conjunction with the accompanying drawings, in which:

FIG. 1 depicts a high-level block diagram of multiple service domains;

FIG. 2 depicts a high-level block diagram of two service domains and their associated networks, showing interaction between network components for providing an enterprise calendar notification service;

FIG. 3 depicts a method according to one embodiment of the present invention;

FIG. 4 depicts a high-level block diagram of two service domains and their associated networks, showing components for providing an enterprise dialing plan service;

FIG. 5 depicts the communication network of FIG. 4 showing the interaction between network components by which a remote user registers a remote user device to use an enterprise dialing plan service;

FIG. 6 depicts a method according to one embodiment of the present invention;

FIG. 7 depicts the communication network of FIG. 4 showing the interaction between network components by which a remote user utilizes an enterprise dialing plan service via a remote user device to establish a call to a local user device;

FIG. 8 depicts a method according to one embodiment of the present invention;

FIG. 9 depicts the communication network of FIG. 4 showing the interaction between network components by which a local user utilizes an enterprise dialing plan service via a local user device to establish a call to a remote user device;

FIG. 10 depicts a method according to one embodiment of the present invention; and

FIG. 11 depicts a high-level block diagram of a general-purpose computer suitable for use in performing the functions described herein.

To facilitate understanding, identical reference numerals have been used, where possible, to designate identical elements that are common to the figures.

### DETAILED DESCRIPTION OF THE INVENTION

The present invention provides service-level interaction between different service domains, thereby enabling users connected via one service domain to utilize services typically only available when connected via another service domain. A service domain may include a specific type of network supporting services and providing those services in a particular manner (e.g., using specific network elements, protocols, and the like). For example, service domains may include networks such as enterprise networks, carrier telephony networks, IP television (IPTV) networks, cable television networks, cellular networks, and the like, as well as various combinations thereof.

In one embodiment, the present invention provides service-level interaction between an enterprise network and a non-enterprise network, thereby enabling enterprise users at remote locations (i.e., at home, on vacation, or at other locations remote from the enterprise campus) to utilize services typically only available to the enterprise users while on the enterprise campus (i.e., while in the office). In one embodiment, the present invention supports an enterprise calendar notification service using a non-enterprise network. In one embodiment, the present invention supports an enterprise dialing plan service using a non-enterprise network. Although primarily depicted and described with respect to these services, the present invention may be used to provide various other enterprise services via non-enterprise networks.

Although primarily depicted and described with respect to translating services between non-enterprise networks and enterprise networks, the present invention may be more generally defined as translating services between a first service domain and a second service domain, where such service domains may include non-enterprise networks, enterprise networks, or any other networks. Although primarily depicted and described herein with respect to embodiments in which the non-enterprise network used to provide an enterprise service is a carrier telephony network and/or an IPTV network, various other non-enterprise networks may be used in accordance with the present invention (e.g., cellular networks, cable television networks, and the like, as well as various combinations thereof).

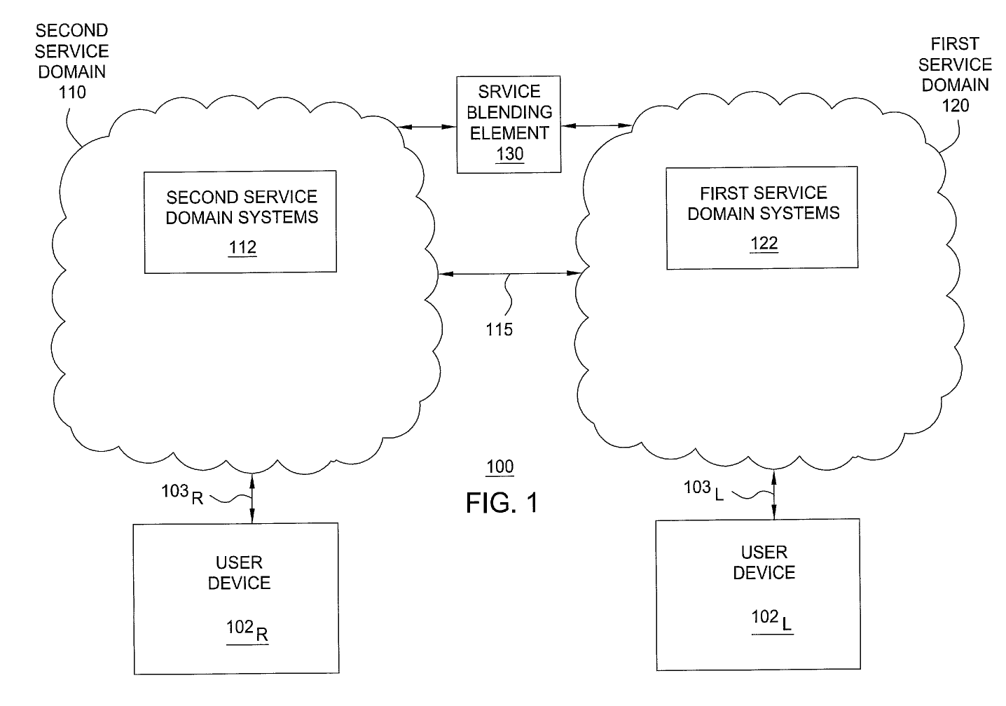

FIG. 1 depicts a high-level block diagram of multiple service domains. Specifically, the multiple service domains 100 include a first service domain 120 and a second service domain 110. As depicted in FIG. 1, a user may access second service domain 110 using a user device 102_{R} (via an access communication path 103_{R}) and a user may access first service domain 120 using a user device 102_{L} (via an access communication path 103_{L}). In one embodiment, the same user is associated with user devices 102_{R} and 102_{L}. In one embodiment, different users are associated with user devices 102_{R} and 102_{L}. Although primarily depicted and described herein with respect to two service domains, the present invention may be implemented using more than two service domains.

As depicted in FIG. 1, a service blending element 130 communicates with first service domain 120 and second service domain 110 for providing service blending functions. The service blending element 130 enables the combination of simpler, more basic services into compound services through specific control software (which may also be referred to herein as blending algorithm). The blending algorithm(s) enable execution of base services or specific portions of base services. The blending algorithms coordinate the execution of the base services (or portions of base services) via message exchanges with the base service(s) and/or other message sources/sinks such as other network elements, users via various user devices (e.g., keyboards, remote controls, and the like), and the like, as well as various combinations thereof.

For example, a service blending algorithm could order a caller-ID display to follow an incoming call alert, and then order that the processing of the incoming call would continue according to one or more requests received from the user receiving the incoming call (e.g., where the user may initiate the request(s) through TV remote control signals) in response to the caller-ID notification. It will be understood that the foregoing example is merely one example of the use of a service blending algorithm. The service blending algorithms of the present invention may be executed to provide service blending for various other base services available from various other types of service domains.

In order to more fully explain the use of service blending algorithms, other embodiments in which service blending algorithms are employed are depicted and described in additional detail herein.

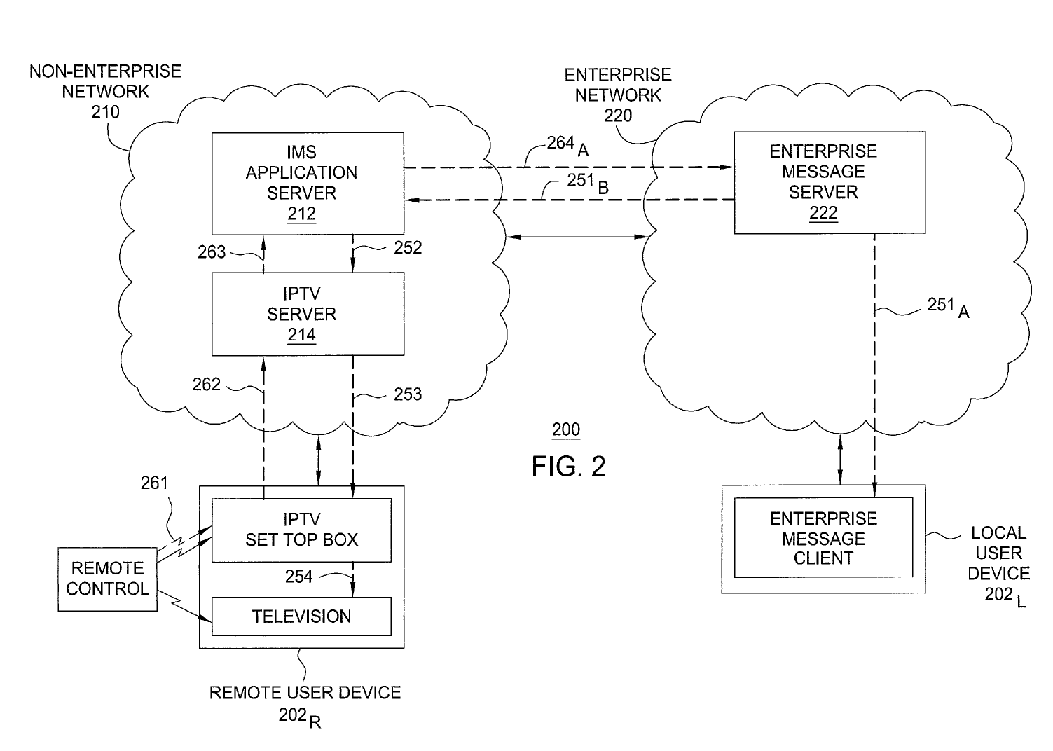

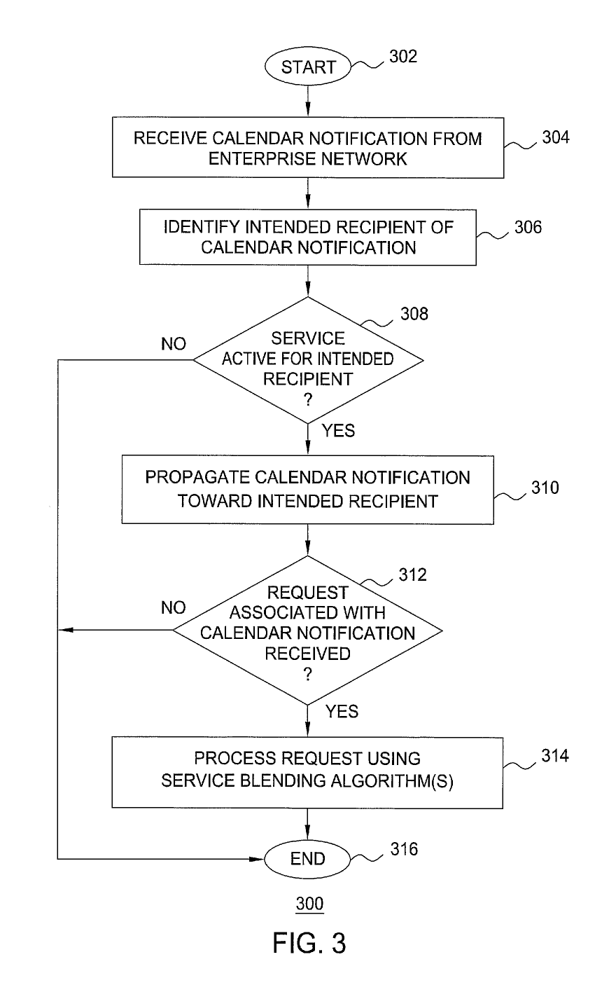

In one embodiment, service blending is used to provide a blended notification service whereby a notification originating in one service domain may be delivered to a user via one or more other service domains and, further, the user may request one or more additional actions in response to the notification where such requests may be served by any service domain or domains. This example is depicted and described herein with respect to FIG. 2-FIG. 3.

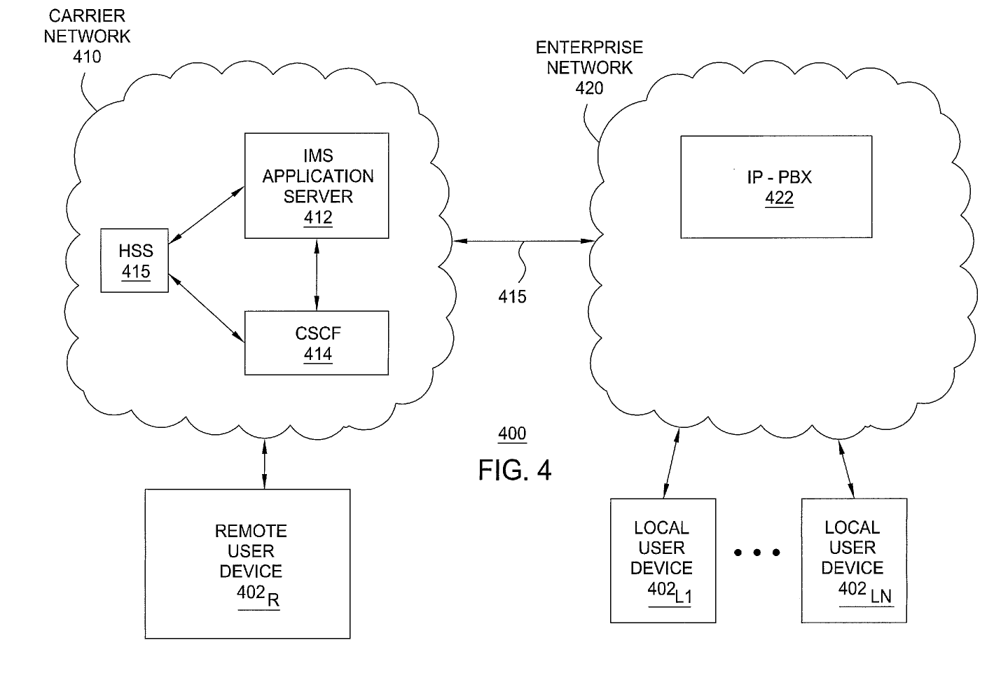

In one embodiment, service blending is used to provide a blended dialing plan service whereby a user associated with a first service domain is able to use a dialing plan of a second service domain in order to place calls to users in the second service domain (or, alternatively, one or more other service domains). This example is depicted and described herein with respect to FIG. 4-FIG. 10.

The service blending element 130 may be deployed in many ways. In one embodiment, as depicted in FIG. 1, the service blending element 130 may be deployed such that it is located outside of the service domains for which it performs service blending functions (illustratively, service blending element 130 is located between first service domain 120 and second service domain 110). In other embodiments, the service blending element 130 may be deployed such that it is located within one or more of the service domains (e.g., located only within first service domain 120, located only within second service domain 110, and the like, as well as various combinations thereof).

Although primarily depicted and described herein as a single functional element, the functions of service blending element 130 may be distributed across multiple functional elements. The multiple functional elements may be deployed in various ways (e.g., outside of service domains and/or within one or more service domains). As depicted in FIG. 1, for example, functions of service blending element 130 may be distributed across one or more systems of first service domain 120 (e.g., one or more of first service domain systems 122) and/or one or more systems of second service domain 110 (e.g., one or more of second service domain systems 112) and/or on one or more other elements outside of first service domain 120 and second service domain 110. The functions of service blending element 130 may be distributed in various other ways.

As described herein, service domains may operate in many different ways (e.g., enterprise networks, carrier telephony networks, IPTV networks, and the like, as well as various combinations thereof). In one embodiment, second service domain 110 is a non-enterprise network and first service domain 120 is an enterprise network. The service blending module 130 enables non-enterprise network to provide enterprise services (i.e., services previously only available via the enterprise network) to a user via the non-enterprise network. As depicted in FIG. 1, the user may access the enterprise network services locally from within the enterprise network using a local user device (illustratively, user device 102_{L} via an access communication path 103_{L}) or remotely from outside the enterprise network using a remote user device (illustratively, user device 102_{R} via an access communication path 103_{R}).

The local user device may include any user device directly connected to the enterprise network (i.e., one or more user devices located at the enterprise location where the user works). For example, the local user device may include a telephone, computer, or other user device located in the office of the user. The remote user device may include any user device(s) not directly connected to enterprise network (i.e., one or more user devices remote from the enterprise location where the user works, and which access the non-enterprise network). For example, the remote user device may include a telephone, computer, television, or other user device located outside the office of the user (e.g., at the user's home or any other location at which the user does not have direct access to the enterprise network).

The second service domain 110 includes second service domain system(s) 112, which, in the case of a non-enterprise network, may include various different components which may depend on the type of non-enterprise network (e.g., servers, routers, and the like, as well as various combinations thereof). For example, in the case in which the second service domain 110 is a carrier telephony network, second service domain system(s) 112 may include application servers providing any services, such as call forwarding servers, voicemail servers, email servers, and the like, as well as various combinations thereof. The second service domain system(s) 112 provide services to the remote user device.

In one embodiment, in which the second service domain 110 is a non-enterprise network, second service domain 110 may be implemented using various different technologies. In one embodiment, for example, the non-enterprise network may be implemented as an IP Multimedia Subsystem (IMS) network. In this embodiment, second service domain systems 112 may include an IMS application server and other IMS network components, such as one or more Call Session Control Functions (CSCFs), one or more Media Servers (MSs), a Home Subscriber Server (HSS), and the like, as well as various combinations thereof.

The first service domain 120 includes first service domain system(s) 122, which, in the case of an enterprise network, may include various different components which may depend on the types of services available from the enterprise network (e.g., servers, routers, IP-PBXs, and the like, as well as various combinations thereof). For example, in the case in which the first service domain 120 is an enterprise network supporting email and VoIP telephony, first service domain system(s) 122 may include an email server, an IP-PBX, and the like. The first service domain system(s) 122 provide services to the local user device.

The operation of first service domain 120 and second service domain 110 in providing services across service domains (e.g., providing enterprise calendar notification service, enterprise dialing plan service, and the like, as well as various combinations thereof from an enterprise network to a remote user via one or more non-enterprise networks) may be better understood with respect to FIG. 2-FIG. 10.

FIG. 2 depicts a high-level block diagram of two service domains and their associated networks, showing interaction between network components for providing an enterprise calendar notification service. Specifically, in the depicted embodiment, the enterprise calendar notification service is provided using an enterprise network 220 and a non-enterprise network 210, which communicate via a communication path 215. The non-enterprise network 210 and enterprise network 220 comprise specific implementations of first service domain 120 and second service domain 110 depicted and described herein with respect to FIG. 1, respectively.

The non-enterprise network 210 is a combination of a carrier telephony network and an IPTV network. Specifically, the non-enterprise network 210 is an IMS-based network including an IMS application server 212 and an IPTV server 214.

The IMS application server 212 comprises an instantiation of service blending element 130 depicted and described with respect to FIG. 1. The IMS application server 212 executes one or more service blending algorithms to perform various functions of the calendar notification service (e.g., delivering a notification received from a first service domain to an intended recipient via a second service domain, initiating messages within the second service domain, to the first service domain, and/or to any other service domains in response to requests received from the user related to a delivered notification, and like functions, as well as various combinations thereof).

The non-enterprise network 210 serves a remote user device 202_{R}. The remote user 202_{R} is a user device including a message client, or any other client which may support calendar notifications or other similar notifications. For example, remote user device 202_{R} may be an IP-based television system including an IPTV set top box (STB) and a television (or some other device or devices adapted for receiving and displaying calendar notifications).

The enterprise network 220 includes an enterprise message server 222. The enterprise message server 222 is a messaging server supporting any service or services which may support calendar notifications or other similar notifications (e.g., an email service, a calendar management service, and the like). For example, the enterprise message server 222 may be a Microsoft Exchange Server.

The enterprise network 220 serves a local user device 202_{L}. The local user device 202_{L} is a user device supporting a message client or any other client which may support calendar notifications or other similar notifications. For example, local user device 202_{L} may be a computer including a Microsoft Outlook client (or some other device or devices adapted for receiving and displaying calendar notifications).

As described herein, the present invention enables the non-enterprise network 210 to provide an enterprise calendar notification service to the user at remote user device 202_{R}. The enterprise message server 222 of enterprise network 220, upon detecting that a calendar notification is due to be provided to a user, sends the calendar notification to both: (1) local user device 202_{L} via enterprise network 120 (denoted as step 251_{A}) and (2) IMS application server 212 of non-enterprise network 110 (denoted as step 251_{B}).

A calendar notification is a reminder about an event, and may include information associated with the event. For example, a calendar notification may include information such as a date of the event, a time at which the event is scheduled to begin, a duration of the event a place at which the event will take place, a telephone number (e.g., of a participant, a conference bridge, and the like) required to participate in the event, scheduled participants, information about the event (e.g., a title of the meeting, an agenda for the meeting, and the like), and the like, as well as various combinations thereof. A calendar notification may include less or more (as well as different) information.

The IMS application server 212 of non-enterprise network 210, upon receiving the calendar notification from enterprise message server 222, determines whether or not the calendar notification should be delivered to remote user device 202_{R}. The IMS application server 212 may determine whether the calendar notification should be delivered to remote user device 202_{R} by determining whether or not a particular service (e.g., in this case, the IPTV service) is active at the remote user device 202_{R}.

The IMS application server 121, upon determining that the calendar notification should be delivered to remote user device 202_{R}, delivers the calendar notification to remote user device 202_{R} via non-enterprise network 210. In one embodiment, IMS application server 121 adapts the calendar notification received from enterprise network 220. For example, where the calendar notification is formatted according to the enterprise network from which it is received, IMS application server 212 may adapted the calendar notification such that it is formatted according to the non-enterprise network over which it is to be delivered.

In this embodiment, for example, the calendar notification may be adapted in many ways (e.g., into a format adapted for transmission via non-enterprise network 210, into a format adapted for display via remote user device 202_{R}, and the like, as well as various combinations thereof). The calendar notification may be adapted in various other ways depending on various factors (e.g., the type of notification, the implementation of the enterprise network, the type of non-enterprise network and implementation of that non-enterprise network, and the like, as well as various combinations thereof).

The IMS application server 212 propagates the calendar notification to IPTV server 214 (denoted as step 252). The IPTV server 214 propagates the calendar notification to remote user device 202_{R} (denoted as step 253). As depicted in FIG. 2, remote user device 202_{R} includes an IPTV set top box, a television, and at least one associated remote control device. The IPTV set top box receives the calendar notification from the IPTV server 214. The IPTV set top box delivers the calendar notification to the television (denoted as step 254), which displays the calendar notification to the remote user.

In one embodiment, the remote user may interact with the displayed calendar notification. The remote user may request one or more actions in response to the calendar notification. For example, upon reviewing a calendar notification displayed on the television, the remote user may acknowledge receipt of the calendar notification, request that the calendar notification be dismissed (i.e., a “dismiss” options), request that the calendar notification be provided again in the future (i.e., a “snooze” option), request that a telephone call be established based on information included in the calendar notification, and the like, as well as various combinations thereof.

For example, upon reviewing the calendar notification, the remote user may wish to dismiss the calendar notification. The remote user may dismiss the calendar notification using one or more buttons on the remote control (or using any other means of interacting with the IPTV set top box). In this example, a message indicative of the request by the remote user to dismiss the calendar notification (denoted as a DISMISS message) is generated at the remote user device 202_{R}, and propagated from remote user device 202_{R} to enterprise message server 222 via IPTV server 214 and IMS application server 212. In this example, upon receiving the DISMISS message, the enterprise message server 222 clears the calendar notification so that it is not repeated.

For example, upon reviewing the calendar notification, the remote user may wish to receive the calendar notification again in the future. In this example, the remote user may select a “snooze” option using one or more buttons on the remote control (or using any other means of interacting with the IPTV set top box). In this example, a message indicative of the request by the remote user to repeat the calendar notification (denoted as a SNOOZE message) is generated at the remote user device 202_{R},

In one embodiment, the SNOOZE message is propagated from remote user device 202_{R} to enterprise message server 222 via IPTV server 214 and IMS application server 212. In this embodiment, upon receiving the SNOOZE message, enterprise message server 222 schedules the calendar notification to be repeated in the future. The length of time after which (or the time at which) the calendar notification should be repeated may be specified by the user when electing the “snooze” option (e.g., the remote user is presented with options to snooze the message for 5 minutes, 15 minutes, 1 hour, and the like) and included in the SNOOZE message, or may be determined by enterprise message server 222.

In one embodiment, the SNOOZE message is propagated from remote user device 202_{R} to IMS application server 212 via IPTV server 214. In this embodiment, upon receiving the SNOOZE message, IMS application server 212 schedules the calendar notification to be repeated in the future. In this embodiment, IMS application server 212 may trigger a message to enterprise message server 222 to clear the message (since IMS application server 212 is proxying on behalf of enterprise message server 222). In this embodiment, the interaction by which the remote user requests the snooze option may be similar to that described with respect to the embodiment in which enterprise message server 222 processes the SNOOZE message.

In one embodiment, in which the calendar notification specifies a telephone number for a telephone call or conference call associated with the calendar notification, presentation of the calendar notification to the user at remote user device 202_{R} may include an option by which the user may request to be connected to the telephone number. In this embodiment, the remote user may elect the “automatic connect” option using one or more buttons on the remote control (or using any other means of interacting with the IPTV set top box). The remote user may indicate that the call should be established now (i.e., in response to the “connect” request from the remote user), or automatically at a time in the future (e.g., at a time specified in the calendar notification or at a time specified by the remote user via remote user device 202_{R}).

In this embodiment, upon receiving an indication from the remote user that the remote user wants to be automatically connected to the call, remote user device 202_{R} generates a CONNECT message indicative of this request, and propagates the CONNECT message to IMS application server 212 via IPTV server 214. In this embodiment, upon receiving the CONNECT message the IMS application server 212 either initiates a call establishment request or schedules a future call establishment request (depending on whether the call is to take place now or in the future). At the scheduled time for the call, IMS application server 212 initiates messaging required to set up the call for the remote user (e.g., to remote user device 202_{R} or another device associated with the remote user).

As depicted in FIG. 2, various different requests may be initiated by the remote user in response to the calendar notification (e.g., request to dismiss, request to snooze, request to establish a call, and the like). As depicted in FIG. 2, the request is initiated via a remote control to the remote user device 202_{R} (denoted as step 261). The request is propagated from the remote user device 202_{R} to non-enterprise network 210 (illustratively, from remote user device 202_{R} to IPTV server 214 (denoted as step 262) and from IPTV server 214 to IMS application server 212 (denoted as step 263).

Upon receiving the request, IMS application server 212 determines how to handle the request. The handling of the request may be performed according to one or more service blending algorithms. The different types of requests may be handled in different ways (which may require interaction from non-enterprise network 210 to one or more other networks (illustratively, enterprise network 220, a carrier telephony network 270, and the like, as well as various combinations thereof). As such, depending on the type of request that is initiated by the remote user, the network over which the calendar notification is delivered to the remote user may need to support interaction with one or more other networks.

For example, a request to dismiss the message or a request to snooze the message may result in generation of a control message that is adapted to complete the request, and propagation of the control message from the non-enterprise network back to the enterprise network (e.g., to a message server from which the calendar notification originated). In this example, the non-enterprise network must support interaction with the enterprise network 220 such that IMS application server 212 may provide the dismiss/snooze request back to enterprise message server 222 (denoted as step 264_{A}).

For example, a request to setup a call using information included in the calendar notification may result in initiation of one or more signaling or other control messages adapted for establishing a call between a user device of the intended recipient and one or more other user devices (e.g., for a call within another user, a conference bridge, and the like).). In this example, the non-enterprise network must support interaction with the carrier telephony network 270 such that IMS application server 212 may initiate a call setup request by which the remote end user may be automatically connected to a call (denoted as step 264B). The call may be established to remote user device 202_{R} or, as depicted in FIG. 2, the call may be established to another remote user device (illustratively, a telephone).

Although primarily depicted and described herein with respect to specific actions requested by the remote user in response to a calendar notification (e.g., dismissing the calendar notification, snoozing the calendar notification, and requesting an automatic call setup based on the calendar notification), various other actions may be requested by the remote user in response to receiving a calendar notification at a remote user device. In other words, the present invention is not intended to be limited to or by the specific actions depicted and described herein.

The operation of IMS application server 212 in providing the enterprise calendar notification service via non-enterprise network 210 may be better understood with respect to FIG. 3.

FIG. 3 depicts a method according to one embodiment of the present invention. Specifically, method 300 of FIG. 3 includes a method for providing an enterprise calendar notification service via a non-enterprise network. Although primarily depicted and described as being performed serially, at least a portion of the steps of method 300 of FIG. 3 may be performed contemporaneously, or in a different order than depicted and described with respect to FIG. 3. The method 300 begins at step 302 and proceeds to step 304.

At step 304, a calendar notification is received from the enterprise network. For example, the calendar notification may be received from an enterprise message server. For example, the calendar notification may be received from a Microsoft Exchange server or other message server adapted for providing calendar notifications. The calendar notification includes information about an event (e.g., a meeting, a conference call, or any other event for which a calendar entry may be created and a calendar notification may be provided).

At step 306, the intended recipient of the received calendar notification is determined. The intended recipient of the received calendar notification may be determined from information included in the calendar notification (e.g., from one or more fields of the calendar notification).

At step 308, a determination is made as to whether a service of the non-enterprise network is active for the intended recipient. The service is the service by which the calendar notification is to be delivered to the intended recipient. The determination as to whether a service of the non-enterprise network is active may be performed in many ways (e.g., by checking a local database, pinging or querying a device of the intended recipient, and the like, as well as various combinations thereof).

In one embodiment, in which the non-enterprise network is a network supporting an IPTV service, the determination as to whether the service is active for the intended recipient is a determination as to whether the IPTV service is active for the intended recipient of the calendar notification.

In this embodiment, the determination as to whether IPTV service is active for the intended recipient may be performed in different ways (e.g., by checking a local database, determining whether an IPTV-based user device of the intended recipient is powered on or powered off, and the like, as well as various combinations thereof).

If the service is not active for the intended recipient of the calendar notification, method 300 proceeds to step 316, where method 300 ends (i.e., the calendar notification will not be delivered to the intended recipient). If the service is active for the intended recipient of the calendar notification, method 300 proceeds to step 310.

At step 310, the calendar notification is propagated toward the intended recipient via the non-enterprise network (e.g., via one or more components of the non-enterprise network, where the components may vary for different non-enterprise networks). The calendar notification is received at a user device of the intended recipient and displayed to the intended recipient. As described herein, the intended recipient may or may not initiate a request in response to the calendar notification.

In one embodiment, in which the non-enterprise network is a network supporting an IPTV service, the calendar notification may be propagated toward an IPTV server that is serving the intended recipient of the calendar notification, which may then deliver the calendar notification to the intended recipient via an IPTV-based user device. In this embodiment, the calendar notification may be received by an IPTV set top box and delivered from the IPTV set top box to an associated television for display to the intended recipient.

At step 312, a determination is made as to whether or not a request associated with the calendar notification is received from the user device of the intended recipient. If a request is not received, method 300

For example, the request may include a request to dismiss the calendar notification, a request to snooze the calendar notification, a request to setup a call based on information included in the calendar notification, a request to schedule a future call setup based on information included in the calendar notification, and the like, as well as various combinations thereof.

At step 314, the request is processed. The request may be processed using one or more service blending algorithms. The processing of the request may depend on the type of request.

For example, a request to dismiss the message or a request to snooze the message may result in generation of a control message that is adapted to complete the request, and propagation of the control message from the non-enterprise network back to the enterprise network (e.g., to a message server from which the calendar notification originated).

For example, a request to setup a call using information included in the calendar notification may result in initiation of one or more signaling or other control messages adapted for establishing a call between a user device of the intended recipient and one or more other user devices (e.g., for a call within another user, a conference bridge, and the like).

At step 316, method 300 ends.

Although depicted and described as ending if the service is not active for the intended recipient of the calendar notification when the calendar notification is received, in one embodiment the application server may store the calendar notification and, upon detecting that the service is active, may then propagate the calendar notification toward the intended recipient via the non-enterprise network.

In one embodiment, the application server may store the calendar notification until it has expired. In one such embodiment, the application server may store the calendar notification irrespective of when the calendar notification is schedule to expire. In another such embodiment, the application server may store the calendar notification only if the calendar notification is not scheduled to expire before a threshold amount of time.

For example, if the calendar notification indicates that a meeting is scheduled to take place in 10 minutes, it may not be beneficial to store the calendar notification (since the notification will expire shortly). By contrast, if the calendar notification indicates that a meeting is schedule to take place in 24 hours, it may be beneficial to store the calendar notification so that the calendar notification can be delivered to the user if the user activates the service any time within the next 24 hours.

In such embodiments, method 300 may be adapted to include a step whereby, if the service is not active, the application server monitors (either continuously or periodically) for the service to switch from being inactive to being active. If the service does not become active before the calendar notification expires, method 300 would proceed to method 316 (i.e., method 300 would end). If the service does become active before the calendar notification expires, method 300 would proceed to step 310 (i.e., the calendar notification would then be propagated toward the intended recipient).

Although depicted and described as ending if a request is not received from intended recipient, it should be noted that in some embodiments method 300 will not end immediately; rather, method 300 may transition to step 316 and end at a later time (e.g., to give the intended recipient enough time to review the calendar notification and initiate a request in response to it). This may be implemented in a number of ways.

In one embodiment, the application server (or other element running this method) may wait a predetermined amount of time before method 300 transitions to step 316 and ends. In one embodiment, the application server (or other element running this method) may wait until the calendar notification has expired (e.g., based on the start time of the event, the end time of the event, or some other indicator) before method 300 transitions to step 316 and ends.

Although primarily depicted and described with respect to providing enterprise calendar notifications via an IMS-based carrier network supporting IPTV service, enterprise calendar notifications may be provided via other types of networks using other types of message delivery. Although primarily depicted and described with respect to providing calendar notifications, the principles of the present invention may be applied to delivering other types of notifications originating in an enterprise network to a user remote from the enterprise network (e.g., via a non-enterprise network).

As such, although primarily depicted and described herein with respect to propagating calendar notifications from an enterprise network to a non-enterprise network, the present invention may be more generally thought of as enabling propagation of any type of notification from a first service domain to a second service domain. Similarly, although primarily depicted and described herein with respect to using the non-enterprise network and the enterprise network to perform one or more actions in response to a request from an intended recipient of a calendar notification, actions performed in response to any type of notification may be performed using any number of service domains (which may or may not include the service domains used to deliver the notification and/or may or may not include other service domains not used to deliver the notification).

FIG. 4 depicts a high-level block diagram of two service domains and their associated networks, showing components for providing an enterprise dialing plan service. Specifically, in the depicted embodiment, the enterprise dialing plan service is provided using a non-enterprise network (illustratively, a carrier network 410) and an enterprise network 220, which communicate via a communication path 415. The non-enterprise network 410 and enterprise network 420 comprise specific implementations of first service domain 120 and second service domain 110 depicted and described herein with respect to FIG. 1, respectively.

The carrier network 410 is an IMS-based network including an IMS application server 412 and additional IMS network components including a Call Session Control Function (CSCF) 414 and a Home Subscriber Server (HSS) 415. The IMS application server 412, CSCF 414, and HSS 415 are adapted to provide the enterprise dialing plan service (i.e., adapted to support enterprise dialing plans within carrier network 410).

The IMS application server 412 comprises an instantiation of service blending element 130 depicted and described with respect to FIG. 1. In one embodiment, IMS application server 412 and one or more other components may comprise the instantiation of the service blending element 130 depicted and described with respect to FIG. 1. For example, IMS application server 412 and HSS 415 may comprise an instantiation of service blending element 130. For example, IMS application server 412 and IP-PBX 422 may comprise an instantiation of service blending element 130.

The IMS application server 412 (and, optionally, one or more other elements of the first service domain and/or second service domain and/or one or more other service domains) executes one or more service blending algorithms to perform various functions of the enterprise dialing plan service (e.g., enabling a user to register an user device associated with a first service domain to use a dialing plan of a second service domain, enabling the user of the registered user device to place calls from the registered user device of the first service domain to user devices of one or more other service domains, enabling users of one or more other service domains to place calls to the user at the registered user device in the first service domain, and the like, as well as various combinations thereof).

The enterprise network 420 includes an IP-PBX 422. The IP-PBX 422 processes telephone calls for enterprise network 420 (i.e., for any user devices directly connected to enterprise network 420). The IP-PBX 422 may process internal telephone calls (where all user devices involved in the call are directly connected to the enterprise network) and external calls (where at least one of the user devices involved in the call is not directly connected to the enterprise network).

The IP-PBX processes internal telephone calls using an enterprise dialing plan, which enables users to place telephone calls by dialing fewer digits than would be required to place external telephone calls. For example, in an enterprise dialing plan, each telephone may be assigned a separate number (in addition to the standard telephone number associated with the telephone) by which that telephone may be reached. In other words, the enterprise dialing plan makes it easier for employees to place telephone calls to each other while in the office.

For example, in an enterprise dialing plan, each telephone directly connected to the enterprise network may be assigned an enterprise dialing plan number (e.g., a two digit number, a four digit number, the last four digits of the standard telephone number assigned to that telephone, and the like).

For example, a telephone connected to an enterprise network that is assigned a standard telephone number of 732-555-1434 may be dialed from other telephones connected to the enterprise network by dialing an enterprise dialing plan number of 1434.

The IP-PBX 422 is adapted to communicate with carrier network 410 for enabling carrier network 410 to support enterprise dialing plans. The IP-PBX 422 is adapted to communicate with IMS application server 412 to enable remote employees to register their remote user devices for the enterprise dialing plan service. The IP-PBX 422 is adapted to communicate with CSCF 414 to enable remote employees to utilize the enterprise dialing plan from their remote user devices.

The enterprise network 420 serves local user devices 402_{L1}-402_{LN} (collectively, local user devices 402_{L}). The local user devices 402_{L} comprise user devices at the enterprise campus served by enterprise network 420. The local user devices 402_{L} comprise user devices by which users may place and receive telephone calls. For example, local user devices 402_{L} may comprise telephones in different offices at the enterprise campus served by enterprise network 420.

The carrier network 210 serves a remote user device 202_{R}. The remote user device 202_{R} may be any user device by which a user may place and receive telephone calls (e.g., a telephone, a computer, and the like). Although one remote user device 202_{R} is depicted, the remote employee may utilize one user device to register for and utilize the enterprise dialing plan service, or may use separate user devices to register for and utilize the enterprise dialing plan service.

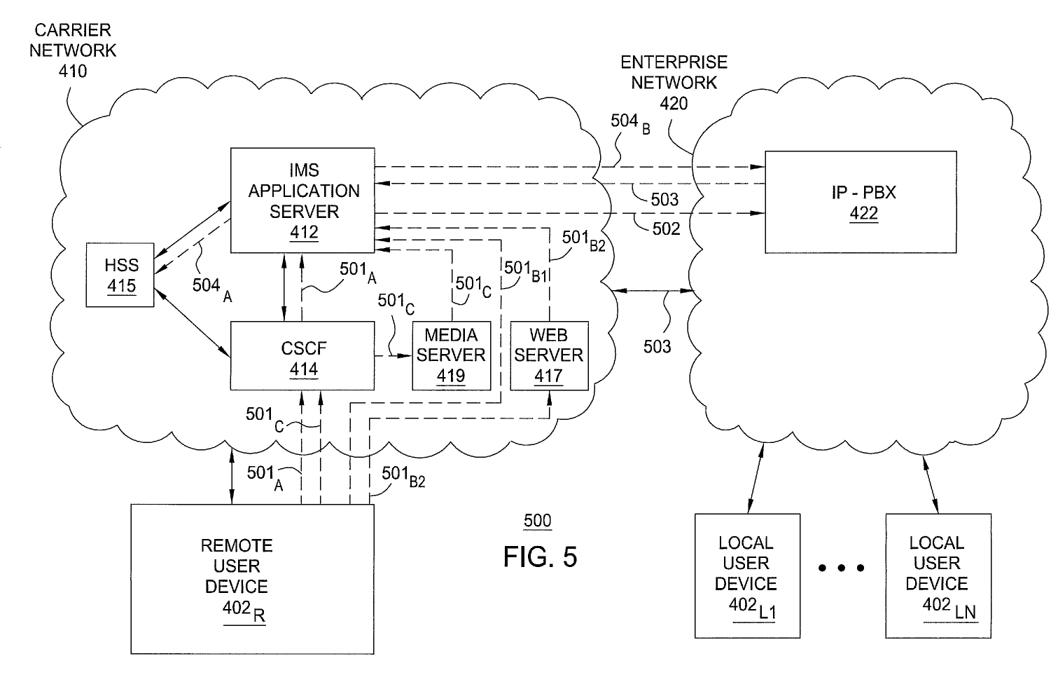

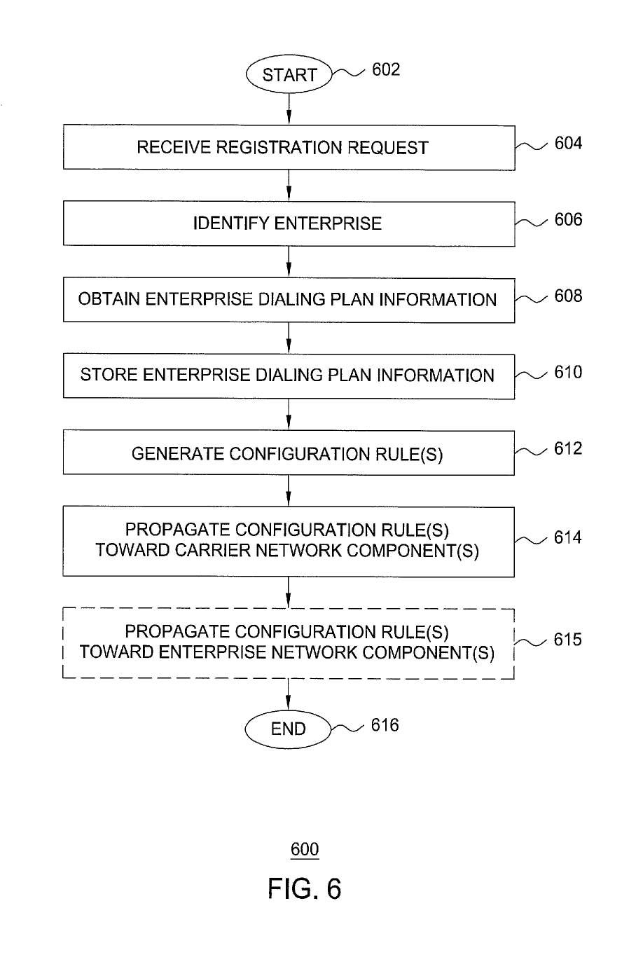

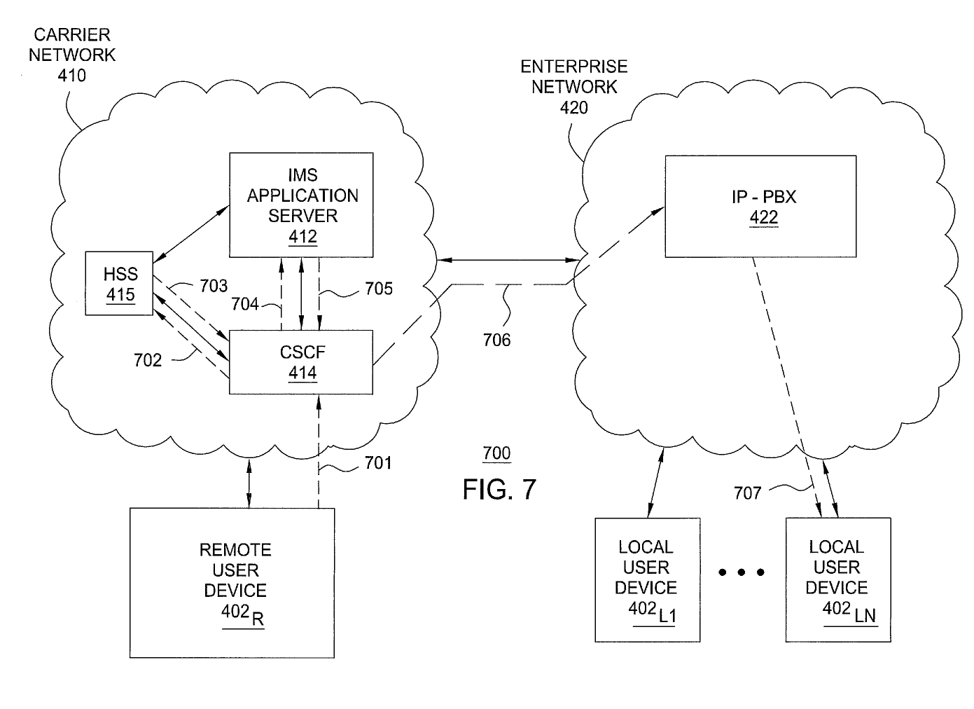

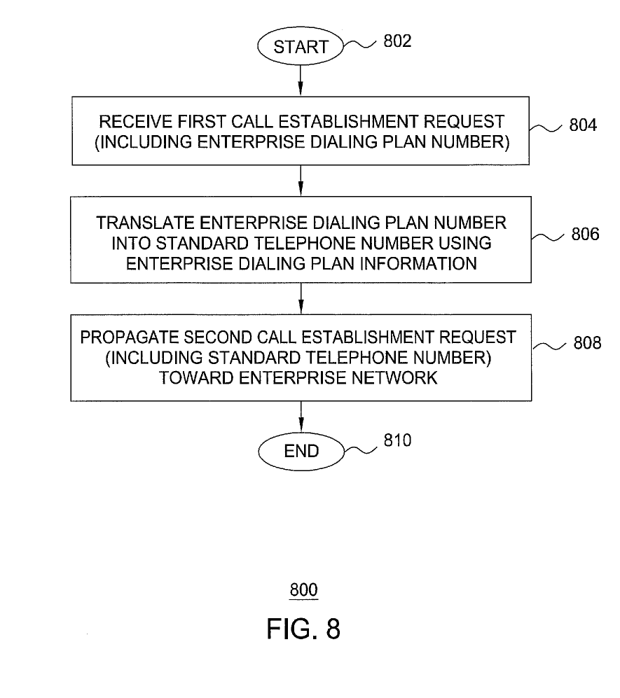

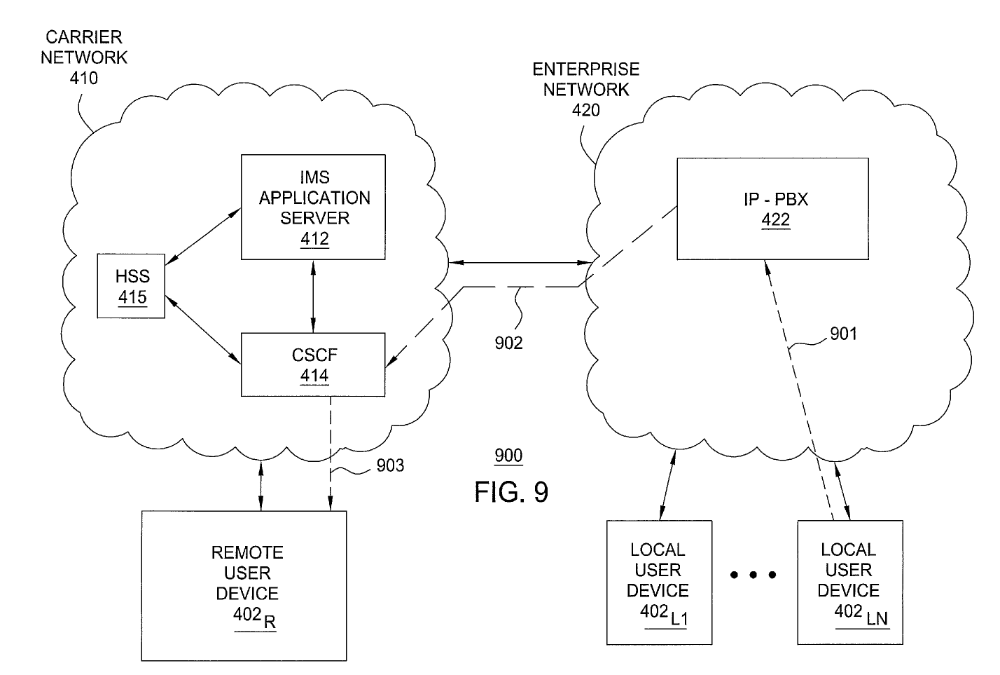

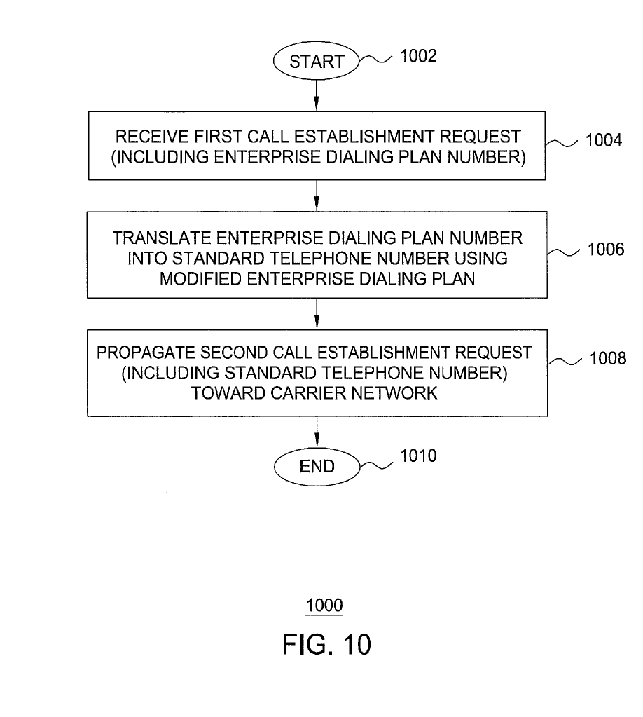

The present invention enables the carrier network 110 and enterprise network 120 to provide an enterprise dialing plan service for the remote user at remote user device 202_{R}. A process by which the remote user registers the remote user device 202_{R} for the enterprise dialing plan service may be better understood with respect to FIG. 5 and FIG. 6. A process by which the remote user uses the enterprise dialing plan service to communicate with local users of the enterprise network 120 may be better understood with respect to FIG. 7 and FIG. 8. A process by which a local user uses the enterprise dialing service to communicate with the remote user via remote user device 202_{R} via non-enterprise network 110 may be better understood with respect to FIG. 9 and FIG. 10.

FIG. 5 depicts the communication network of FIG. 4 showing the interaction between network components by which a remote user registers a remote user device to use an enterprise dialing plan service.

As depicted in FIG. 5, a user initiates a registration request to register remote user device 402_{R} for an enterprise dialing plan service (i.e., to be able to use an enterprise dialing plan remotely). In one embodiment, as depicted in FIG. 5, the registration request is initiated from the remote user device that being registered. In another embodiment (omitted for purposes of clarity), the registration request is initiated from a device other than the remote user device that being registered (e.g., using a different phone, computer, or other device).

The registration request identifies the user requesting registration, the remote user device for which registration is requested (illustratively, remote user device 402_{R}, although it could be a separate user device), and, optionally, the enterprise with which the user is associated (i.e., employed). The registration request may include other information, which may be provided in a number of different ways depending on the manner in which the remote user initiates the registration request.

The registration request is directed to IMS application server 412, which is adapted for processing the registration request and configuring the carrier network 410 in response to the registration request. The registration request may be directed to IMS application server 412 in a number of ways (depending on the manner in which the remote user initiates the registration request).

In one embodiment, the remote user initiates a registration request from remote user device 402_{R}, e.g., where remote user device 402_{R} is a VoIP phone. The remote user device 402_{R} transmits a registration request message to CSCF 414. The CSCF 414 receives the registration request message from remote user device 402_{R}. The CSCF 414 forwards the registration request message to IMS application server 412. In FIG. 5, this embodiment is denoted as step 501_{A}.

In one embodiment, the remote user initiates a registration request from remote user device 402_{R}, e.g., where remote user device 402_{R} is a computer and the remote user initiates the registration request via a web interface. In this embodiment, the remote user device 402_{R} may provide the registration request to IMS application server 412 either directly or indirectly. The remote user device 402_{R} may provide the registration request to IMS application server 412 indirectly via a web server (illustratively, web server 417), which receives the registration request and forwards the registration request to IMS application server 412. In FIG. 5, this embodiment is denoted as steps 501_{B1} (direct) and 501_{B2} (indirect).

In one embodiment, the remote user initiates a registration request from remote user device 402_{R}, e.g., where remote user device 402_{R} is a phone and the remote user initiates the registration request via an interactive voice response (IVR) system. In this embodiment, the remote user device 402_{R} provide the registration request information to a media server hosting an IVR application (illustratively, media server 419), which receives the registration request and forwards the registration request to IMS application server 412. In FIG. 5, this embodiment is denoted as steps 501_{C}.

The IMS application server 412 receives the registration request (in one of the depicted ways in which the registration request may be initiated and propagated to IMS application server 412). The IMS application server 412 identifies the user requesting registration (e.g., from the registration request message). The IMS application server 412 further identifies the enterprise of the user requesting registration. The IMS application server 412 may identify the enterprise in a number of ways.

If the registration request message includes the enterprise of the user requesting registration, the enterprise is identified directly from the registration request message. If the registration request message does not include the enterprise of the user requesting registration, the enterprise may identified using other information included in the registration request message (e.g., by performing a lookup based on the user identified in the registration request message).

The IMS application server 412 requests an enterprise dialing plan (or at least information associated with an enterprise dialing plan) from the identified enterprise. The IMS application server 412 transmits a request for enterprise dialing plan information to the network of the identified enterprise. As depicted in FIG. 5, IMS application server 412 transmits the request for the enterprise dialing plan information to IP-PBX 422 of enterprise network 420 (denoted as step 502).

The request for enterprise dialing plan information may be a generic request for enterprise dialing plan information that is not specific to the requesting user, or a specific request for enterprise dialing plan information that is specific to the requesting user (in which case the request may include information adapted for use by IP-PBX 422 in retrieving the enterprise dialing plan information for that particular user). In one embodiment, the request for dialing plan information may be generated and propagated using one or more service blending algorithms.

The IP-PBX 422 receives the request for the enterprise dialing plan information from IMS application server 412. The IP-PBX 422 retrieves the requested enterprise dialing plan information. The IP-PBX 422 transmits the retrieved enterprise dialing plan information to IMS application server 412 (denoted as step 503) for use in provisioning carrier network 410 to support the enterprise dialing plan service for the requesting user. The enterprise dialing plan information provided from IP-PBX 422 to IMS application server 412 may include any information which may be associated with an enterprise dialing plan.

The enterprise dialing plan information provided from IP-PBX 422 to IMS application server 412 may depend on the type of enterprise dialing plan used by the enterprise. In one embodiment, for example, the enterprise dialing plan information includes a set of rules from which IMS application server 412 may translate an enterprise dialing plan number of a local user device into the corresponding standard telephone number of that local user device. The set of rules may include rules that generic to the enterprise and/or specific to the user for that enterprise. The enterprise dialing plan information may include any other information which may be associated with an enterprise dialing plan.

For example, where the enterprise dialing plan assigns enterprise dialing plan numbers which can be derived from the associated standard telephone number, the enterprise dialing plan information may include one or more rules for translating an enterprise dialing plan number of a local user device into the corresponding standard telephone number of that local user device. For example, where the enterprise dialing plan uses a rule specifying that the last four digits of the standard telephone number as the enterprise dialing plan number, IP-PBX 422 may provide that rule to IMS application server 412.

For example, where the enterprise dialing plan assigns enterprise dialing plan numbers which cannot be derived from the associated standard telephone number, the enterprise dialing plan information may include a full mapping of all enterprise dialing plan numbers and all associated standard telephone numbers for all local user devices of the enterprise network. For example, IP-PBX 422 may provide an enterprise dialing plan number of 742 to IMS application sever 412 for a particular local end user device even though the standard telephone number associated with that local end user device is 732-555-1434.

The IMS application server 412 receives the enterprise dialing plan information from IP-PBX 422. The IMS application server 412 uses the enterprise dialing plan information to provision the carrier network 410 (and, optionally, the enterprise network 420) to support the enterprise dialing plan for remote user device 402_{R}. The IMS application server 412 provisions components of carrier network 410 to support the enterprise dialing plan service (denoted as steps 504_{A}). In one embodiment, at least a portion of the provisioning functions performed by IMS application server 412 may be performed using one or more service blending algorithms.

The IMS application server 412 stores the enterprise dialing plan information for use in providing the enterprise dialing plan service to remote user device 402_{R}. The IMS application server 412 uses the stored enterprise dialing plan information to translate enterprise dialing plan numbers, received from remote user device 402_{R} via CSCF 414, into corresponding standard telephone numbers using the enterprise dialing plan information. The IMS application server 414 performs the translation in a manner transparent to the end user.

The IMS application server 412 provisions HSS 415 to support the enterprise dialing plan service for remote user device 402_{R} (denoted as step 504_{A}). In one embodiment, for example, IMS application server 412 informs HSS 415 that remote user device 402_{R} is registered for the enterprise dialing plan service, such that HSS 415 may inform CSCF 414 to direct requests to use the enterprise dialing plan (i.e., requests received at CSCF 414 from the remote user device 402_{R}) to IMS application server 412 (which can perform the number translation function in a manner transparent to the end user).

In one embodiment, IMS application server 412 generates one or more filter criteria rules using the enterprise dialing plan received from IP-PBX 422 (and, optionally, information included in the registration request from remote user device 402_{R}). In this embodiment, IMS application server 412 propagates the filter criteria rule(s) to HSS 415, which stores the filter criteria rule(s) for use in providing the enterprise dialing plan service to the requesting user from remote user device 402_{R}.

In one embodiment, IMS application server 412 may also provision the enterprise network 420 to support the enterprise dialing plan service (denoted as step 504_{B}). In this embodiment, IMS application server 412 may propagate configuration information to enterprise network 420 (e.g., to IP-PBX 422, or any other components requiring such information) such that the enterprise network 420 is adapted to support use of the enterprise dialing plan by users at local user devices 402_{L} to place calls to the remote end user at remote user device 402_{R}. In one embodiment, the IMS application server 412 provisions enterprise network 420 using one or more service blending algorithms.

The configuration information provided from IMS application server 412 to IP-PBX 422 at least includes: (1) information identifying the end user that is requesting the enterprise dialing plan service and (2) the standard telephone number of the remote user device 402_{R} that is being registered by that end user. The configuration information may include other information adapted for use in configuring the enterprise network to support the use of the enterprise dialing plan to call remote user devices registered for the enterprise dialing plan service.

Using this information, IP-PBX 422 is able to maintain a mapping of the enterprise dialing plan number to the associated standard telephone number of the remote user device 402_{R} being registered by that end user. In one embodiment, this mapping may be maintained as part of the enterprise dialing plan stored on IP-PBX 422 (i.e., the enterprise dialing plan stored on IP-PBX 422 is modified using the configuration information received from the carrier network 410).

Thus, when an local end user places a call to the remote end user via one of the local user devices 402_{L}, the IP-PBX 422 translates the enterprise dialing plan number that is received from the local user device 402_{L} into the corresponding standard telephone number using the stored mapping. The IP-PBX 422 then completes the call request to the remote user device 402_{R} using the standard telephone number (i.e., as if the local end user had dialed the standard telephone number).

In one such embodiment, IMS application server 412 configures the enterprise network 420 after IMS application server 412 configures the carrier network 410 to support the enterprise dialing plan service. For example, the

IMS application server 412 may propagate the configuration information to IP-PBX 422 after storing the enterprise dialing plan information and propagating configuration information to HSS 415.

In another such embodiment, IMS application server 412 configures the enterprise network 420 while the IMS application server 412 configures the carrier network 410 to support the enterprise dialing plan service. For example, the IMS application server 412 may propagate the configuration information to IP-PBX 422 as part of the request for enterprise dialing plan information that IMS application server 412 transmits to IP-PBX 422 in response to receiving the registration request (i.e., as part of step 502).

The operation of IMS application server 412 in enabling a remote user to register a remote user device for enterprise dialing plan service, including configuration of the carrier network (and, optionally, also configuration of the enterprise network) in support of the enterprise dialing plan service, may be better understood with respect to FIG. 6.

FIG. 6 depicts a method according to one embodiment of the present invention. Specifically, method 600 of FIG. 6 includes a method for providing an enterprise dialing plan service via a carrier network. In one embodiment, at least a portion of the steps of method 600 may be performed using one or more service blending algorithms. Although depicted and described as being performed serially, at least a portion of the steps of method 600 of FIG. 6 may be performed contemporaneously, or in a different order than depicted and described with respect to FIG. 6. The method 600 begins at step 602 and proceeds to step 604.

At step 604, a registration request is received. The registration request is a request from a user to register a remote user device for an enterprise dialing plan service (i.e., so that the user can use an enterprise dialing plan from a user device outside of the enterprise network, e.g., from home, from a hotel while on vacation, and the like).

At step 606, the enterprise of the registration request (i.e., enterprise for which the enterprise dialing plan service is requested) is identified. The enterprise is identified from the registration request or using information included within the registration request.

At step 608, the enterprise dialing plan (or at least some information associated with the enterprise dialing plan) is obtained. The enterprise dialing plan information is obtained from one or more systems of the enterprise network.

At step 610, the enterprise dialing plan information is stored. The stored enterprise dialing plan information may be used to provide the enterprise dialing plan service to the registered user via the remote user device.

At step 612, a configuration rule (or rules) is generated. The configuration rule is generated using at least a portion of the dialing plan information and, optionally, at least a portion of the information included in the registration request. In one embodiment, the configuration rule(s) is a filter criteria rule(s).

For example, the configuration rule may indicate that a call request received from the remote user device (where the call request specifies an enterprise dialing plan number) should be forwarded to an application server adapted to provide the enterprise dialing plan service to the remote user device.

At step 614, the configuration rule(s) is propagated toward one or more components of the carrier network. In one embodiment, for example, in which the carrier network is an IMS-based carrier network, the configuration rule is propagated toward a HSS of the IMS-based carrier network.

For example, the configuration rule may be used by the HSS to instruct a CSCF which receives a call request (e.g., a call request received from the remote user device and which specifies an enterprise dialing plan number) to redirect the call request from the CSCF to an application server adapted to provide the enterprise dialing plan service to the remote user device.

At step 615 (an optional step), configuration information is propagated to one or more components of the enterprise network such that the enterprise network is adapted to support use of the enterprise dialing plan by users at local user devices to place calls to the remote end user at the remote user device.

The configuration information propagated from the carrier network to the enterprise network may identify the remote user and identify the standard telephone number assigned to the remote user device being registered by the remote end user (and may also include any other information which may be required to adapt the enterprise network according to the enterprise dialing plan server).

At step 616, method 600 ends. Following completion of the registration process by which the user is registered to utilize the enterprise dialing plan remotely, the registered user may then utilize the enterprise dialing plan from the remote user device registered by that user, as depicted and described with respect to FIG. 7 and FIG. 8.

FIG. 7 depicts the communication network of FIG. 4 showing the interaction between network components by which a remote user utilizes an enterprise dialing plan service via a remote user device to establish a call to a local user device.

As depicted in FIG. 7, a user initiates a call from remote user device 402_{R} to one of the local user devices 402_{L} (illustratively, to 402_{LN}). The user initiates the call by dialing a number according to the enterprise dialing plan (denoted as an enterprise dialing plan number), rather than dialing a standard telephone number.

For example, for an enterprise dialing plan in which the last four digits of the standard telephone number may be dialed to reach the user device associated with the standard telephone number, the user dials the last four digits of the standard telephone number. For example, the user dials 1434 for a standard telephone number of 732-555-1434.

The remote user device 402_{R} transmits a call establishment request to CSCF 414 (denoted as step 701). The call establishment request identifies the remote user device 402_{R} from which the call is initiated, and includes the enterprise dialing plan number dialed by the user.

The CSCF 414 receives the call establishment request from remote user device 402_{R}. The CSCF 414 queries HSS 415 in order to determine the handling of the call establishment request (denoted as step 702). The CSCF 414 queries HSS 415 using information identifying remote user device 402_{R} from which the call establishment request is received. The query request may also include the enterprise dialing plan number dialed by the user.

The HSS 415 receives the query request from CSCF 414. The HSS 415 uses the information identifying remote user device 402_{R} to determine handling of the call establishment request. The HSS 415 may use information identifying remote user device 402_{R} to obtain a profile associated with the remote user device 402_{R}, or to identify the user associated with the remote user device 402_{R} in order to order to obtain a profile associated with user of remote user device 402_{R}.

The HSS 415 uses the profile in order to inform CSCF 414 about the proper handling of the call establishment request. Specifically, in this case, HSS 415 determines that remote user device 402_{R} is registered for enterprise dialing plan service. Additionally, HSS 415 determines that, since the dialed number is a non-standard number, the call establishment request from remote user device 402_{R} should be routed from CSCF 414 to IMS application server 412 in order to translate the enterprise dialing plan number into a standard telephone number.

The HSS 415 transmits call establishment request handling information to CSCF 414 (denoted as step 703). The call establishment request handling information includes information adapted for use by CSCF 414 in routing the call establishment request received from remote user device 402_{R} to a carrier network component that is adapted to handle the call establishment request (namely, IMS application server 412).

The CSCF 414 receives the call establishment request handling information from HSS 415. The CSCF 414 forwards the call establishment request received from remote user device 402_{R} to IMS application server 412 based on the received call establishment request handling information (denoted as step 704).

The IMS application server 412 receives the call establishment request (which identifies remote user device 402_{R} from which the call establishment request was initiated and which includes the enterprise dialing plan number) from CSCF 414. The IMS application server 412 translates the enterprise dialing plan number included in the call establishment request into the corresponding standard telephone number using enterprise dialing plan information associated with the enterprise for which the call establishment request is intended.

The IMS application server 412 translates the enterprise dialing plan number into the corresponding standard telephone number by identifying the enterprise for which the call establishment request is intended, retrieving the enterprise dialing plan information for the identified enterprise, and applying the enterprise dialing plan information to the enterprise dialing plan number in to translate the enterprise dialing plan number into the standard telephone number.

The IMS application server 412 may identify the enterprise in a number of ways (e.g., from an enterprise identifier included in the call establishment request, using an identifier of remote user device 402_{R} to perform a lookup to identify the enterprise, and the like). The IMS application server 412 retrieves the enterprise dialing plan information based on the identified enterprise (e.g., using an enterprise identifier, using an enterprise name, and the like).

The IMS application server 412 may perform the translation from the enterprise dialing plan number to the standard telephone number in a number of ways (which, as described herein, may depend on the enterprise dialing plan information).

In one embodiment, in which the enterprise dialing plan information includes a set of rules, IMS application server 412 may apply one or more of the rules of the enterprise dialing plan information to the enterprise dialing plan number included in the call establishment request in order to determine the corresponding standard telephone number associated with the enterprise dialing plan number.

In one embodiment, in which the enterprise dialing plan information includes mappings of enterprise dialing plan numbers to corresponding standard telephone numbers, IMS application server 412 may perform a simple lookup in order to identify the standard telephone number associated with the enterprise dialing plan number included in the call establishment request.

The IMS application server 412, upon translating the enterprise dialing plan number into the corresponding standard telephone number, propagates a call establishment request toward enterprise network 420. Specifically, the IMS application server 412 propagates the call establishment request back to CSCF 414 (denoted as step 705), and the CSCF 414 propagates the call establishment request toward IP-PBX 422 using the standard telephone number of the local user device 402_{LN} for which the call establishment request is intended (denoted as step 706).

In one embodiment, the call establishment request returned from IMS application server 412 to CSCF 414 for propagation toward IP-PBX 422 is a modified version of the call establishment request received at IMS application server 412 from remote user device 402_{R} via CSCF 414. In this embodiment, IMS application server 412 modifies the received call establishment request to replace the enterprise dialing plan number with the corresponding standard telephone number. The modified call establishment request may include other modifications.

In one embodiment, the call establishment request returned from IMS application server 412 to CSCF 414 for propagation toward IP-PBX 422 is a new call establishment request (i.e., the initial call establishment request received at IMS application server 412 is terminated by IMS application server 412). In this embodiment, IMS application server 412 generates a new call establishment request including the standard telephone number (rather than the enterprise dialing plan number).

The IP-PBX 422 receives the call establishment request from CSCF 414. The IP-PBX identifies the local user device 402_{L} for which the call establishment request is intended using the standard telephone number included in the call establishment request (e.g., in the manner in which IP-PBX 422 would process any other incoming call). The IP-PBX 422 forwards the call establishment request to the local user device 402_{LN} for which the call establishment request is intended (denoted as step 707).

The local user device 402_{LN} receives the call establishment request from IP-PBX 422, which causes local user device 402_{LN} to ring, thereby informing the user of local user device 402_{LN} of the incoming call from the user of remote user device 402_{R}. The call establishment may then proceed as normal. If the user of the local user device 402_{LN} answers the call, the call establishment is completed and the users may communicate. If the user of the local user device 402_{LN} does not answer the call, the user of remote user device 402_{R} may be directed to voicemail (or some other call handling may be applied).

Thus, using the present invention, remote users are able to register remote endpoints outside of the enterprise network for an enterprise dialing plan service which enables the remote users to use the enterprise dialing plan from the registered remote endpoints. The translation of enterprise dialing plan numbers to corresponding standard telephone numbers is transparent to the users. The enterprise dialing plan service may be used in conjunction with any other telephony services.

The operation of IMS application server 412 in providing an enterprise dialing plan service to a remote user via a remote user device, including the messaging within the carrier network and number translation functions supported by IMS application server 412, may be better understood with respect to FIG. 8.

FIG. 8 depicts a method according to one embodiment of the present invention. Specifically, method 800 of FIG. 8 includes a method for providing an enterprise dialing plan service via a carrier network. In one embodiment, at least a portion of the steps of method 800 may be performed using one or more service blending algorithms. Although primarily depicted and described as being performed serially, at least a portion of the steps of method 800 of FIG. 8 may be performed contemporaneously, or in a different order than depicted and described with respect to FIG. 8. The method 800 begins at step 802 and proceeds to step 804.

At step 804, a first call establishment request is received. The first call establishment request is received at a component of the carrier network (e.g., an application server). The first call establishment request is a request from a remote user via a remote user device (i.e., one that is not connected to the enterprise network) to establish a call with a local user via a local user device (i.e., one connected to the enterprise network). The first call establishment request includes an enterprise dialing plan number.

At step 806, the enterprise dialing plan number is translated into a standard telephone number using enterprise dialing plan information. The number translation is performed by identifying the enterprise for which the call establishment request is intended, retrieving the enterprise dialing plan information for the identified enterprise, and applying the enterprise dialing plan information to translate the enterprise dialing plan number into the standard telephone number.

As described herein, the enterprise dialing plan number may be translated into the standard telephone number using the enterprise dialing plan information in a number of ways (e.g., by applying one or more rules to the enterprise dialing plan number in order to derive the corresponding standard telephone number, by using a mapping of the enterprise dialing plan number to the corresponding standard telephone number, and the like, as well as various combinations thereof).

At step 808, a second call establishment request is propagated toward the enterprise network. The second call establishment request includes the standard telephone number determined from the enterprise dialing plan number using the enterprise dialing plan information.

The second call establishment request may be: (1) a modified version of the first call establishment request (e.g., where the enterprise dialing plan number is replaced with the corresponding standard telephone number), or (2) a new call establishment request that is generated using the standard telephone number (rather than the enterprise dialing plan number). The second call establishment request may be formed in any other manner.

The second call establishment request is propagated toward the enterprise network based on the standard telephone number (i.e., in the manner in which any phone call placed from outside of the enterprise network to one of the local user device of the enterprise network would be propagated from a carrier network to that enterprise network). The second call establishment request may be propagated toward the enterprise network in any manner.

At step 810, method 800 ends. Although depicted and described as ending, additional messaging will be performed in order to complete the call establishment request to the local user device of the enterprise network and, further, to handle the call establishment after the call establishment request has been propagated to the local user device (e.g., complete the call if the local user answers, forward the call to voicemail if the local user does not answer, and the like).

FIG. 9 depicts the communication network of FIG. 4 showing the interaction between network components by which a local user utilizes an enterprise dialing plan service via a local user device to establish a call to a remote user device.

As depicted in FIG. 9, a user initiates a call from a first one of the local user devices 402_{L} (illustratively, from 402_{LN}) to a second one of the local user devices 402_{L} (illustratively, to 402_{L1}). The user initiates the call by dialing a number according to the enterprise dialing plan (denoted as an enterprise dialing plan number), rather than dialing a standard telephone number.

For example, for an enterprise dialing plan in which the last four digits of the standard telephone number may be dialed to reach the user device associated with the standard telephone number, the user dials the last four digits of the standard telephone number. For example, the user dials 1434 for a standard telephone number of 732-555-1434.

In this case, although the user initiating the call may or may not know it, the user associated with the second local user device 402_{L} (illustratively, to 402_{L1}) has registered a remote user device (illustratively, remote user device 402R for the enterprise dialing plan service). Thus, by dialing the enterprise dialing plan number for that user, the dialing user may reach the dialed user either at his local user device 402_{L1} or his remote user device 402_{R}.

The local user device 402_{LN} transmits a call establishment request to IP-PBX 422 (denoted as step 701). The call establishment request includes the enterprise dialing plan number dialed by the user. The call establishment request may include other information (e.g., identifying the local user device 402_{LN} from which the call is initiated).

The IP-PBX 422 receives the call establishment request from the local user device 402_{LN}. The IP-PBX 422 uses the enterprise dialing plan stored on the IP-PBX 422 to determine handling of the call establishment request. In this case, the IP-PBX 422 determines that the user associated with local user device 402_{L1} has registered a remote user device for the enterprise dialing plan service.

Thus, the IP-PBX determines that a call establishment request using that enterprise dialing plan number should be routed to remote user device 402_{R} (instead of local user device 402_{L1}). The IP-PBX 422 translates the enterprise dialing plan number into the corresponding standard telephone number (i.e., the standard telephone number assigned to the remote user device 402_{R}) using the modified enterprise dialing plan stored on the IP-PBX 422.

The IP-PBX 422 may perform the translation from the enterprise dialing plan number to the standard telephone number in a number of ways. In one embodiment, IP-PBX 422 may apply one or more of the rules of the enterprise dialing plan to the enterprise dialing plan number in order to determine the corresponding standard telephone number. In one embodiment, IP-PBX 422 may perform a simple lookup in order to identify the standard telephone number associated with the enterprise dialing plan number.

The IP-PBX, upon translating the enterprise dialing plan number into the standard telephone number, propagates a call establishment request toward carrier network 410. Specifically, IP-PBX 422 propagates the call establishment to CSCF 414 (denoted as step 902).

The call establishment request propagated from IP-PBX 422 to CSCF 414 may be modified version of the initial call establishment request received at IP-PBX 422 or may be a new call establishment request generated by IP-PBX 422. In either case, the call establishment request propagated from IP-PBX includes the standard telephone number associated with remote user device 402_{R}.

The CSCF 414 receives the call establishment request from IP-PBX 422. The CSCF 414 identifies the user device for which the call establishment request is intended using the standard telephone number included in the call establishment request (e.g., in the manner in which CSCF 414 would process any other incoming call). In this case, CSCF 414 identifies remote user device 402_{R} as the intended recipient of the call establishment request. The CSCF 414 forwards the call establishment request to remote user device 402_{R} for which the call establishment request is intended (denoted as step 903).

The remote user device 402_{R} receives the call establishment request from CSCF 414, which causes remote user device 402_{R} to ring, thereby informing the user of remote user device 402_{R} of the incoming call from the user of local user device 402_{LN}. The call establishment may then proceed as normal. If the user of the remote user device 402_{R} answers the call, the call establishment is completed and the users may communicate. If the user of the remote user device 402_{R} does not answer the call, the user of local user device 402_{LN} may be directed to voicemail (or some other call handling may be applied).

Thus, using the present invention, remote users are able to register remote endpoints outside of the enterprise network for an enterprise dialing plan service which not only enables the remote users to use the enterprise dialing plan from the registered remote endpoints, but which also enables local users to place calls to the remote users using the enterprise dialing plan. The translation of enterprise dialing plan numbers to corresponding standard telephone numbers is transparent to the users. The enterprise dialing plan service may be used in conjunction with any other telephony services.

The operation of IP-PBX 422 in providing an enterprise dialing plan service to a remote user via a remote user device, including the messaging within the enterprise network and number translation functions supported by IP-PBX 422, may be better understood with respect to FIG. 10.

FIG. 10 depicts a method according to one embodiment of the present invention. Specifically, method 1000 of FIG. 10 includes a method for providing an enterprise dialing plan service via a carrier network. In one embodiment, at least a portion of the steps of method 1000 may be performed using one or more service blending algorithms. Although primarily depicted and described as being performed serially, at least a portion of the steps of method 1000 of FIG. 10 may be performed contemporaneously, or in a different order than depicted and described with respect to FIG. 10. The method 1000 begins at step 1002 and proceeds to step 1004.

At step 1004, a first call establishment request is received. The first call establishment request is received at a call processing component of the enterprise network (e.g., at an IP-PBX). The first call establishment request is a request from a first user via a local user device (i.e., one connected to the enterprise network) to establish a call with a second user, irrespective of whether or not the first user knows that the second user has registered a remote user (i.e., one that is not connected to the enterprise network) for an enterprise dialing plan service. The first call establishment request includes an enterprise dialing plan number.

At step 1006, the enterprise dialing plan number is translated into a standard telephone number using the enterprise dialing plan stored in the enterprise network. The number translation is performed by applying the enterprise dialing plan i to translate the enterprise dialing plan number into the standard telephone number. As described herein, the enterprise dialing plan number may be translated into the standard telephone number using the enterprise dialing plan information in a number of ways.

At step 1008, a second call establishment request is propagated toward the carrier network. The second call establishment request includes the standard telephone number determined from the enterprise dialing plan number using the enterprise dialing plan. The second call establishment request may be a modified version of the first call establishment request or a new call establishment request that is generated in response to the first call establishment request.

The second call establishment request is propagated toward the carrier network based on the standard telephone number (i.e., in the manner in which any phone call placed from inside of the enterprise network to a user device outside of the enterprise network would be propagated from the enterprise network to the required carrier network). The second call establishment request may be propagated toward the carrier network in any manner.

At step 1010, method 1000 ends. Although depicted and described as ending, additional messaging will be performed in order to complete the call establishment request to the remote user device of the carrier network and, further, to handle the call establishment after the call establishment request has been propagated to the remote user device (e.g., complete the call if the remote user answers, forward the call to voicemail if the remote user does not answer, and the like).

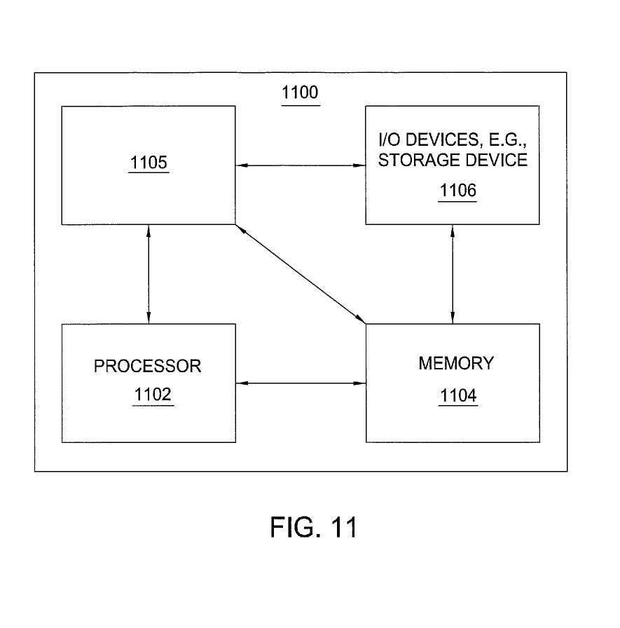

FIG. 11 depicts a high-level block diagram of a general-purpose computer suitable for use in performing the functions described herein. As depicted in FIG. 11, system 1100 comprises a processor element 1102 (e.g., a CPU), a memory 1104, e.g., random access memory (RAM) and/or read only memory (ROM), an enterprise service module 1105, and various input/output devices 1106 (e.g., storage devices, including but not limited to, a tape drive, a floppy drive, a hard disk drive or a compact disk drive, a receiver, a transmitter, a speaker, a display, an output port, and a user input device (such as a keyboard, a keypad, a mouse, and the like)).

It should be noted that the present invention may be implemented in software and/or in a combination of software and hardware, e.g., using application specific integrated circuits (ASIC), a general purpose computer or any other hardware equivalents. In one embodiment, the present enterprise service process 1105 can be loaded into memory 1104 and executed by processor 1102 to implement the functions as discussed above. As such, enterprise service process 1105 (including associated data structures) of the present invention can be stored on a computer readable medium or carrier, e.g., RAM memory, magnetic or optical drive or diskette, and the like.

It is contemplated that some of the steps discussed herein as software methods may be implemented within hardware, for example, as circuitry that cooperates with the processor to perform various method steps. Portions of the present invention may be implemented as a computer program product wherein computer instructions, when processed by a computer, adapt the operation of the computer such that the methods and/or techniques of the present invention are invoked or otherwise provided. Instructions for invoking the inventive methods may be stored in fixed or removable media, transmitted via a data stream in a broadcast or other signal bearing medium, and/or stored within a working memory within a computing device operating according to the instructions.

Although various embodiments which incorporate the teachings of the present invention have been shown and described in detail herein, those skilled in the art can readily devise many other varied embodiments that still incorporate these teachings.

What is claimed is:

1. A method, comprising:
using a processor and a memory for:
receiving, at an element of a non-enterprise network, a request to register a remote user device of a user to use an enterprise dialing plan of an enterprise network of an enterprise;
obtaining enterprise dialing plan information for the enterprise dialing plan of the enterprise network; and
storing the enterprise dialing plan information for the enterprise dialing plan of the enterprise network.

2. The method of claim 1, wherein obtaining the enterprise dialing plan information for the enterprise dialing plan of the enterprise network comprises:
identifying the enterprise associated with the request to register the remote user device to use the enterprise dialing plan of the enterprise network; and
propagating, toward the enterprise network, a request for the enterprise dialing plan information for the enterprise dialing plan of the enterprise network.

3. The method of claim 2, wherein identifying the enterprise associated with the request to register the remote user device to use the enterprise dialing plan of the enterprise network comprises at least one of:
identifying the enterprise based on information included within the request to register the remote user device to use the enterprise dialing plan of the enterprise network; or
performing a lookup, based on an identity of the user, to identify the enterprise associated with the request to register the remote user device to use the enterprise dialing plan of the enterprise network.

4. The method of claim 2, wherein the request for the enterprise dialing plan information for the enterprise dialing plan of the enterprise network comprises a request for enterprise dialing plan information specific to the user.

5. The method of claim 1, wherein the enterprise dialing plan information comprises at least one of:
one or more rules for translating an enterprise dialing plan number of a local user device of the enterprise network into a standard telephone number of the local user device of the enterprise network; or
a mapping of an enterprise dialing plan number of a local user device of the enterprise network to a standard telephone number of the local user device of the enterprise network.

6. The method of claim 1, further comprising:
initiating provisioning of the non-enterprise network to support use of the enterprise dialing plan.

7. The method of claim 6, wherein initiating provisioning of the non-enterprise network to support use of the enterprise dialing plan comprises:
propagating, toward a home subscriber server (HSS), information indicative that the remote user device is registered to use the enterprise dialing plan.

8. The method of claim 7, wherein the information comprises one or more filter criteria rules generated based on the enterprise dialing plan information.

9. The method of claim 1, further comprising:
initiating provisioning of the enterprise network to enable a local user device of the enterprise network to initiate a call to the remote user device of the user using the enterprise dialing plan.

10. The method of claim 9, wherein the configuration information comprises information identifying the user and a standard telephone number of the remote user device of the user.

11. The method of claim 1, further comprising:
receiving, at the non-enterprise network, a call establishment request including an enterprise dialing plan number of a local user device connected to the enterprise network;
translating, based on the enterprise dialing plan information, the enterprise dialing plan number into a standard telephone number of the local user device connected to the enterprise network; and
propagating, from the non-enterprise network toward the enterprise network, a call establishment request including the standard telephone number.

12. A method, comprising:
using a processor and a memory for:
receiving, at an element of a non-enterprise network, a call establishment request including an enterprise dialing plan number of a local user device connected to an enterprise network supporting an enterprise dialing plan;
translating the enterprise dialing plan number, based on enterprise dialing plan information associated with the enterprise dialing plan of the enterprise network, into a standard telephone number of the local user device connected to the enterprise network; and
propagating, toward the enterprise network, a call establishment request including the standard telephone number of the local user device.

13. The method of claim 12, wherein the call establishment request including the enterprise dialing plan number of the local user device is received from a remote user device of a user.

14. The method of claim 13, further comprising:
prior to receiving the call establishment request including the enterprise dialing plan number of the local user device:
receiving, at the element of a non-enterprise network, a request to register the remote user device of the user to use the enterprise dialing plan of the enterprise network;
obtaining the enterprise dialing plan information for the enterprise dialing plan of the enterprise network; and
storing the enterprise dialing plan information for the enterprise dialing plan of the enterprise network.

15. The method of claim 12, wherein the call establishment request including the enterprise dialing plan number of the local user device is received from a call session control function, wherein propagating the call establishment request including the standard telephone number of the local user device toward the enterprise network comprises propagating the call establishment request including the standard telephone number of the local user device toward the call session control function.

16. A method, comprising:
using a processor and a memory for:
receiving, at an element of an enterprise network from an element of a non-enterprise network, a request for enterprising dialing plan information associated with an enterprise dialing plan of the enterprise network; and
propagating, from the element of the enterprise network toward the element of the non-enterprise network, the enterprising dialing plan information associated with the enterprise dialing plan of the enterprise network.

17. The method of claim 16, further comprising:
receiving, at the element of the enterprise network from the non-enterprise network, a mapping of an enterprise dialing plan number associated with a user to a standard telephone number of a remote user device of the user; and
storing the mapping of the enterprise dialing plan number associated with the user to the standard telephone number of the remote user device of the user.

18. The method of claim 17, further comprising:
receiving, at the element of the enterprise network from a local user device of a second user, a call establishment request including the enterprise dialing plan number associated with the user;
translating the enterprise dialing plan number associated with the user into the standard telephone number of the remote user device of the user based on the mapping of the enterprise dialing plan number associated with the user to the standard telephone number of the remote user device of the user; and
propagating, from the element of the enterprise network toward the non-enterprise network, a call establishment request including the standard telephone number of the remote user device of the user.

19. A method, comprising:
using a processor and a memory for:
receiving, at an element of an enterprise network, a call establishment request including an enterprise dialing plan number of a user;
translating the enterprise dialing plan number of the user into a standard telephone number of a remote user device of the user, wherein the remote user device of the user is associated with a non-enterprise network; and
propagating, from the element of the enterprise network toward the non-enterprise network, a call establishment request including the standard telephone number of the remote user device of the user.

20. The method of claim 19, wherein the call establishment request including the enterprise dialing plan number of the user is received from a local user device connected to the enterprise network.

21. The method of claim 19, further comprising:
prior to receiving the call establishment request including the enterprise dialing plan number of the user:
receiving, at the element of the enterprise network from the non-enterprise network, a mapping of the standard telephone number of the remote user device of the user to the enterprise dialing plan number of the user; and
storing the mapping of the standard telephone number of the remote user device of the user to the enterprise dialing plan number of the user.
